(19) United States
(12) Patent Application Publication
(10) Pub. No.: US 2019/0384019 A1
(43) Pub. Date: Dec. 19, 2019

(54) RECEPTACLE BODIES FOR OPTICAL CHIPS AND OPTICAL CONNECTIONS INCORPORATING THE SAME

(71) Applicant: CORNING OPTICAL COMMUNICATIONS LLC, Charlotte, NC (US)

(72) Inventors: Christian Fiebig, Berlin (DE); Martin Hempstead, Painted Post, NY (US); Ulrich Wilhelm Heinz Neukirch, Painted Post, NY (US); Gary Richard Trott, San Mateo, CA (US)

(21) Appl. No.: 16/555,203

(22) Filed: Aug. 29, 2019

Related U.S. Application Data
(63) Continuation of application No. PCT/US18/20874, filed on Mar. 5, 2018.
(60) Provisional application No. 62/467,854, filed on Mar. 7, 2017.

(51) Int. Cl. G02B 6/42

(52) U.S. Cl. CPC G02B 6/423; G02B 6/4292; G02B 6/4239; G02B 6/4243

(57) ABSTRACT

Optical connections and optical receptacle bodies are disclosed. In one embodiment, an optical connection includes an optical chip, a receptacle body and first and second alignment pins. The optical chip includes a surface, an edge extending from the surface, and at least one optical waveguide within the optical chip and terminating at the edge. The receptacle body includes a first surface, a second surface, a first groove at the second surface, a second groove at the second surface, and a through-hole extending from the first surface to the second surface, wherein the through-hole is disposed between the first groove and the second groove. The first alignment pin is disposed on the surface of the optical chip and within the first groove of the receptacle body. The second alignment pin is disposed on the surface of the optical chip and within the second groove of the receptacle body.

### PRIORITY APPLICATIONS

This application is a continuation of International Application No. PCT/US18/20874, filed on Mar. 5, 2018, which claims the benefit of priority to U.S. Application No. 62/467,854, filed on Mar. 7, 2017, both applications being incorporated herein by reference.

### BACKGROUND

The present disclosure generally relates to high-bandwidth optical communication and, more particularly, to receptacle bodies for optical chips and optical connections incorporating the same.

Benefits of optical fiber include extremely wide bandwidth and low noise operation. Because of these advantages, optical fiber is increasingly being used for a variety of applications, including, but not limited to, broadband voice, video, and data transmission. Connectors are often used in data center and telecommunication systems to provide service connections to rack-mounted equipment and to provide inter-rack connections. Accordingly, optical connectors are employed in both optical cable assemblies and electronic devices to provide an optical-to-optical connection wherein optical signals are passed between components.

As the bandwidth of optical transceiver devices is increased by means of advanced techniques such as silicon-based laser systems and wavelength division multiplexing, large amounts of data must be transferred from the active devices and associated electronics to electronic components of the computing device (e.g., a data switching device of a data center) for further processing (e.g., up to 100 Gbps per channel). Further, the optical mode size of optical transceiver devices (e.g., laser diodes, photodiodes) and the core diameter of optical fibers decrease with the transition from multi-mode to single-mode fiber, which presents challenges in maintaining proper alignment between the transceiver device and the optical connector to which it is connected.

In silicon-based photonic devices, such as hybrid-silicon lasers and silicon optical modulators, optical signals are propagated through the device within optical waveguides. In some laser devices, the optical signals exit the device through an edge such that the optical signals do not turn prior to being emitted from the edge. Currently, optical fibers are permanently attached to the optical waveguides at the edge of the silicon-based photonic device or other waveguide substrate (i.e., an optical chip). The optical fibers may be attached to the edge of the optical chip using a UV curable adhesive, for example. The opposite end of the optical fibers may include an optical connector that may be disposed in a front face of a server device for optical connection to external computing components.

However, the alignment of the optical fibers to the optical waveguides at the edge of the optical chip requires an expensive and time consuming active alignment process (e.g., a vision-based active alignment process). Such active alignment processes add significant costs, and severely reduce throughput.

Further, the fiber coatings associated with the optical fibers cannot survive the elevated temperatures of a subsequent solder reflow process. The optical chip will typically be provided on a daughterboard that is attached to a motherboard by a solder reflow process, for example. Thus, the optical fibers cannot be attached to the optical chip until the daughterboard is permanently attached to the motherboard. Therefore, the optical chip and the entire photonics sub-assembly cannot be tested until it is permanently attached to the motherboard and the optical fibers are permanently attached to the edge of the optical chip. If the photonics sub-assembly fails the testing procedure, it must be manually removed from the motherboard and scrapped, resulting in significant costs and reduction in throughput.

Accordingly, alternative devices for providing an optical fiber device capable of being removably coupled to an edge of an optical chip to enable testing of the optical chip prior to a solder reflow process are desired.

### SUMMARY

Embodiments of the present disclosure are directed to optical receptacles that provide for dematable connection with an optical connector of a fiber optic cable. The receptacles described herein make use of an upper (or lower) surface of an optical chip as a reference datum by placing alignment pins directly on the surface of the optical chip and holding them in place via a receptacle body. Minimal contact between the alignment pins and an optical chip and/or receptacle body prevent misalignment due to foreign substances. Further, transparent glass receptacle bodies provide for the ability to use one or more fiducial marks to enable alignment and placement of the receptacle body on an optical chip by machine vision.

In this regard, in one embodiment, a receptacle body for an optical connection includes a first surface, a second surface, a first groove at the second surface, a second groove at the second surface, and a through-hole extending from the first surface to the second surface, wherein the through-hole is disposed between the first groove and the second groove.

In another embodiment, an optical connection includes an optical chip, a receptacle body and first and second alignment pins. The optical chip includes a surface, an edge extending from the surface, and at least one optical waveguide within the optical chip and terminating at the edge. The receptacle body includes a first surface, a second surface, a first groove at the second surface, a second groove at the second surface, and a through-hole extending from the first surface to the second surface, wherein the through-hole is disposed between the first groove and the second groove. The first alignment pin is disposed on the surface of the optical chip and within the first groove of the receptacle body. The second alignment pin is disposed on the surface of the optical chip and within the second groove of the receptacle body. A gap is present between the surface of the optical chip and the second surface of the receptacle body. An adhesive is disposed within the gap.

In yet another embodiment, a receptacle body for an optical connection includes a first surface, a first pin support surface and a second pin support surface, a pedestal including a pedestal surface, and a through-hole extending from the first surface to the pedestal surface. The pedestal is disposed between the first pin support surface and the second pin support surface, and the pedestal surface is offset from the first pin support surface and the second pin support surface.

In yet another embodiment, an optical connection includes an optical chip, a receptacle body, a first alignment pin, and a second alignment pin. The optical chip includes a surface, an edge extending from the surface, at least one optical waveguide within the optical chip and terminating at the edge, a first optical chip groove within the surface and a second optical chip groove within the surface. The receptacle body includes a first surface, a first pin support surface and a second pin support surface, a pedestal includes a pedestal surface, and a through-hole extending from the first surface to the pedestal surface. The pedestal is disposed between the first pin support surface and the second pin support surface, and the pedestal surface is offset from the first pin support surface and the second pin support surface. The first alignment pin is disposed within the first optical chip groove such that the first alignment pin is disposed between the optical chip and the first pin support surface of the receptacle body. The second alignment pin is disposed within the second optical chip groove such that the second alignment pin is disposed between the optical chip and the second pin support surface of the receptacle body. A gap is present between the surface of the optical chip and the pedestal surface of the receptacle body. An adhesive is disposed within the gap.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate embodiments, and together with the description serve to explain principles and operation of the various embodiments.

### BRIEF DESCRIPTION OF THE DRAWINGS

FIG. 1 schematically depicts an example optical chip according to one or more embodiments described and illustrated herein;

FIG. 2 schematically depicts an example glass-plastic hybrid optical fiber ferrule according to one or more embodiments described and illustrated herein;

FIG. 3A schematically depicts a perspective view of a glass faceplate according to one or more embodiments described and illustrated herein;

FIG. 3B schematically depicts a partial view of a glass faceplate in a die for fabricating a glass-plastic hybrid optical fiber ferrule according to one or more embodiments described and illustrated herein;

FIG. 4 schematically depicts a front view of a glass-plastic hybrid optical fiber ferrule according to one or more embodiments described and illustrated herein;

FIG. 5 schematically depicts a front view of another glass-plastic hybrid optical fiber ferrule according to one or more embodiments described and illustrated herein;

FIG. 6 schematically depicts a side view of a glass-plastic hybrid optical fiber ferrule including an optical fiber extending beyond a front face of the glass-plastic hybrid optical fiber ferrule according to one or more embodiments described and illustrated herein;

FIG. 7A schematically depicts a side view of another glass-plastic hybrid optical fiber ferrule including a plastic cover layer and an optical fiber extending beyond a front face of the glass-plastic hybrid optical fiber ferrule according to one or more embodiments described and illustrated herein;

FIG. 7B schematically depicts a side view of the glass-plastic hybrid optical fiber ferrule depicted in FIG. 7A after a polishing process according to one or more embodiments described and illustrated herein;

FIG. 8 schematically depicts a front view of an example glass faceplate according to one or more embodiments described and illustrated herein;

FIG. 9 schematically depicts a perspective view of the example glass faceplate depicted in FIG. 8;

FIG. 10 schematically depicts a perspective view of an example fiber optic connector including an example glass-plastic hybrid optical fiber ferrule according to one or more embodiments described and illustrated herein;

FIG. 11 schematically depicts a top view of an example optical connection comprising a glass-plastic hybrid optical fiber ferrule, a receptacle, and an optical chip according to one or more embodiments described and illustrated herein;

FIGS. 12A and 12B schematically depict side perspective views of the optical connection depicted in FIG. 11;

FIG. 13A schematically depicts a front view of an example optical connection comprising a receptacle and an optical chip according to one or more embodiments described and illustrated herein;

FIG. 13B schematically depicts a bottom perspective view of a receptacle body according to one or more embodiments described and illustrated herein;

FIG. 13C schematically depicts a partial front view of an optical connection comprising a receptacle and an optical chip according to one or more embodiments described and illustrated herein;

FIG. 14 schematically depicts a front view of another example optical connection comprising a receptacle and an optical chip according to one or more embodiments described and illustrated herein;

FIG. 15 schematically depicts a front view of another example optical connection comprising a receptacle and an optical chip according to one or more embodiments described and illustrated herein;

FIG. 16A schematically depicts an example alignment pin comprising a plurality of sub-grooves according to one or more embodiments described and illustrated herein; and

FIG. 16B schematically depicts a partial view of a bottom surface of an example receptacle body comprising an alignment groove having a plurality of sub-grooves according to one or more embodiments described and illustrated herein.

### DETAILED DESCRIPTION

Embodiments described herein are directed to optical fiber ferrules operable to be removably mated to an edge of an optical chip. Thus, embodiments described herein enable optical fibers to be repeatedly mated and de-mated at the optical chip. The ability to connect and disconnect the optical fiber ferrule to and from the optical chip improves the manufacturing process of a photonics sub-assembly including the optical chip, as well as a server device (e.g., a datacenter switch) that incorporates the photonics sub-assembly. The embodiments described herein enable manufactures of photonics sub-assemblies to connect optical fibers within an optical fiber ferrule to an edge of an optical chip, thereby optically coupling the optical fibers of the optical fiber ferrule to optical waveguides of the optical chip. The optical chip may be tested using optical signals sent and received on the optical fibers. If the optical chip and the photonics sub-assembly are deemed satisfactory, the optical fiber ferrule is disconnected from the optical chip and the photonics sub-assembly is subjected to a solder reflow process, which may be utilized to electrically couple one or more photonics sub-assemblies to a motherboard, for example. After the solder reflow process, the optical fiber ferrule may be reconnected to the optical chip.

Optical chips, such as those that perform optical-to-electrical and/or electrical-to-optical conversion, operate at relatively high operating temperatures (e.g., up to 90° C.). The plastic material used to fabricate traditional optical fiber ferrules has a higher coefficient of thermal expansion (CTE) (e.g., about 18 ppm/° C.) than that of the material of the optical chip (e.g., about 3 ppm/° C. depending on the materials). This CTE mismatch may shift the position of the ends of the optical fibers during operation with respect to the optical waveguides, thereby causing misalignment. For single mode optical fibers, the tolerance is typically ±1.0 μm. Thus, plastic optical fiber ferrules holding multiple optical fibers at a small pitch (e.g., less than about 500 μm) are incapable of being connected to an edge of the optical chip due to the CTE of the plastic material and resulting shifting position of the multiple optical fibers.

Embodiments of the present disclosure incorporate a glass faceplate at an end of a glass-plastic hybrid optical fiber ferrule to constrain the ends of the optical fibers maintained within the ferrule. The glass faceplate prevents movement of the ends of the optical fibers due to the CTE of the plastic material so that they remain in proper position and optically coupled to the optical waveguides of the optical chip. Various embodiments of optical fiber ferrules incorporating a glass faceplate and their methods of manufacture are described in detail below.

Embodiments of the present disclosure are also directed to receptacles that make use of an upper (or lower) surface of an optical chip as a reference datum by placing alignment pins directly on the surface of the optical chip and holding them in place via a receptacle body.

Referring now to FIG. 1, a partial perspective view of an optical chip 100 is schematically illustrated. The optical chips 100 described herein may be configured as silicon-based photonic devices, such as hybrid-silicon lasers and silicon optical modulators. The optical chip may be configured as an optical transceiver and/or receiver. As such the optical chip 100, or one or more components optically coupled to the optical chip 100, may include active optical components, such as laser diodes for transmitting optical signals and photodiodes for receiving optical signals (not shown). As used herein, the term “optically coupled” means that optical signals are able to pass between two elements, such as between adjacent optical waveguides, for example.

The optical chip 100 may be configured as one or multiple layers of material such as without limitation, silicon, glass, or indium phosphide. The optical chip 100 comprises one or more optical waveguides 116. The one or more optical waveguides 116 may be disposed within a bulk of the optical chip 100 or on a first surface 113 (e.g., top surface) of the optical chip 100. The one or more optical waveguides have a higher refractive index than the surrounding areas of the material of the optical chip. The one or more optical waveguides 116 may be fabricated from any known or yet-to-be-developed process to modify the index of refraction of the material of the optical chip 100. Example processes include, but are not limited to, ion-exchange processes and laser writing processes. Other optical waveguides may be utilized, such as, without limitation, planar glass dielectric waveguides, embedded optical fiber waveguides, and polymer waveguides.

FIG. 1 depicts a plurality of optical waveguides 116 embedded below the first surface 113 and terminating at an edge 112 of the optical chip 100. The plurality of optical waveguides 116 has a pitch p, which may take on any value depending on the end application. As one non-limiting example, the pitch p may be within a range of 100 μm and 300 μm. As another non-limiting example, the pitch p may be 250 μm. It should be understood that other pitch values may be employed. Any number of optical waveguides 116 may be utilized depending on the design of the optical chip 100. Further, although the optical chip 100 is illustrated with one row of optical waveguides 116, embodiments are not limited thereto. For example, another row of optical waveguides may be located proximate to a second surface 114 opposite from the first surface 113.

It is noted that, in some embodiments, the optical chip 100 may be mounted on a base substrate, such as a circuit board. In embodiments, the optical chip 100 may be component of a sub-assembly (e.g., a daughterboard) of a larger motherboard, such as, without limitation, a motherboard of a server device.

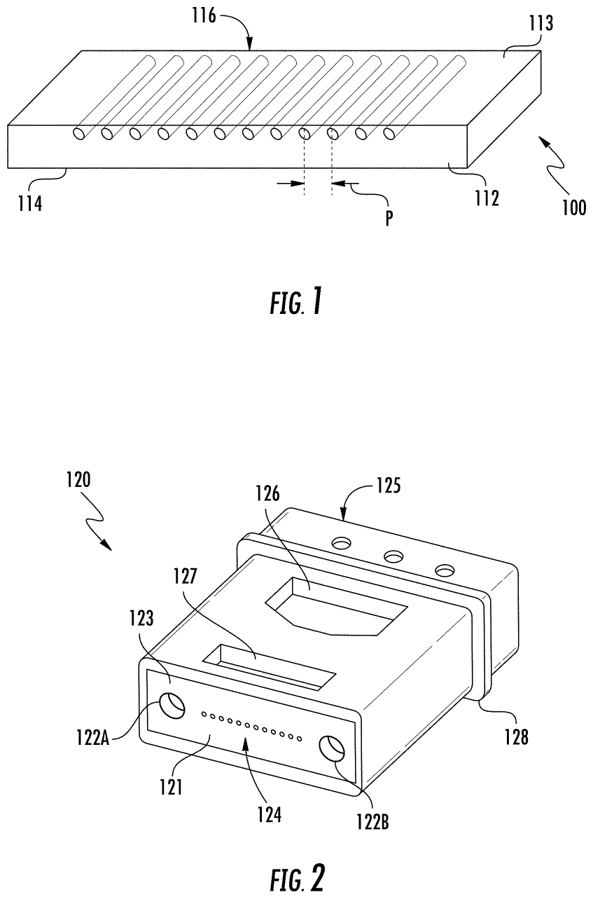

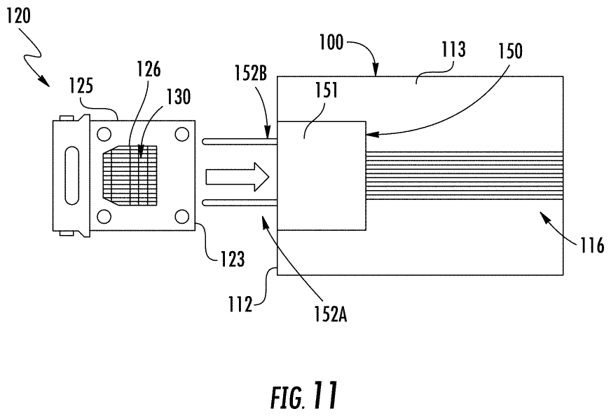

Embodiments of the present disclosure enable de-mateable optical connection to the plurality of optical waveguides 116 at the edge 112 of the optical chip 100. Referring now to FIG. 2, an example optical fiber ferrule 120 is schematically illustrated. The example optical fiber ferrule 120 is configured as a mechanical transfer ferrule (MT ferrule), such as MT-type ferrules sold by US Conec of Hickory, N.C. The example optical fiber ferrules described herein may be incorporated in a fiber optic connector, such as the MT-type fiber optic connector depicted in FIG. 10. It should be understood that embodiments described herein are not limited to MT-type ferrules and connectors, and that the concepts described herein may be incorporated into other optical fiber ferrule configurations.

The optical fiber ferrule 120 comprises a plastic body 125 molded about a glass faceplate 121. CTE matching to the optical chip material is only required at the front face of the optical fiber ferrule 120 which presents the polished fiber ends to their respective optical waveguides 116. Thus, in embodiments, only the front face of the optical fiber ferrule 120 is made of glass, while the remaining portion is made of injection moldable plastic used for current ferrules, for example.

The plastic body 125 may be fabricated from any suitable thermoplastic or thermoset plastic. The plastic body 125 may include optional features such as openings 126 that provide access to optical fibers (not shown) disposed therein. For example, the openings 126 may be filled with adhesive to set the optical fibers in place within the plastic body.

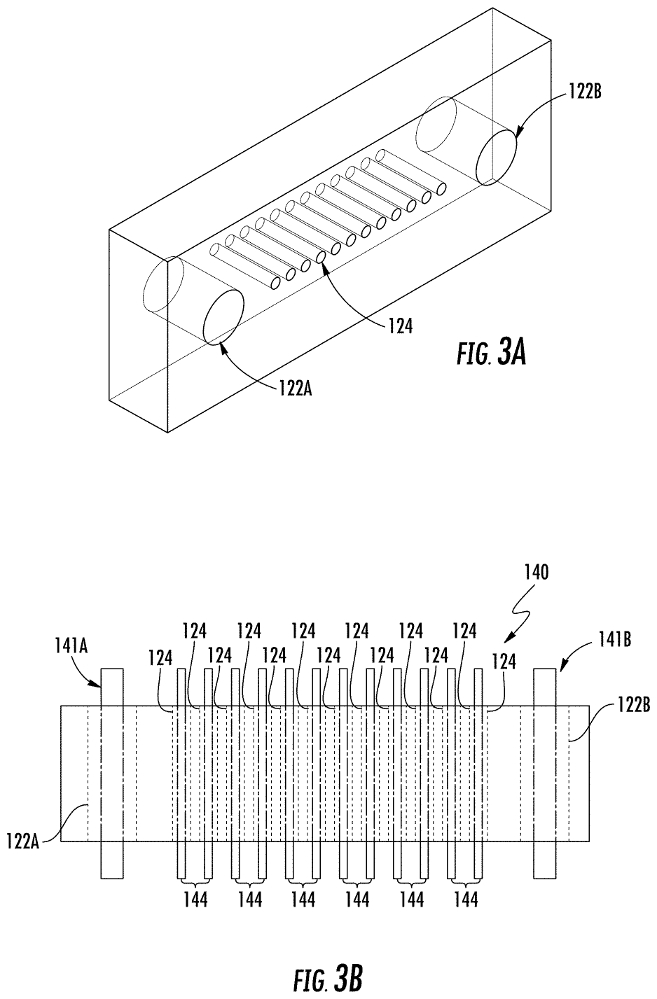

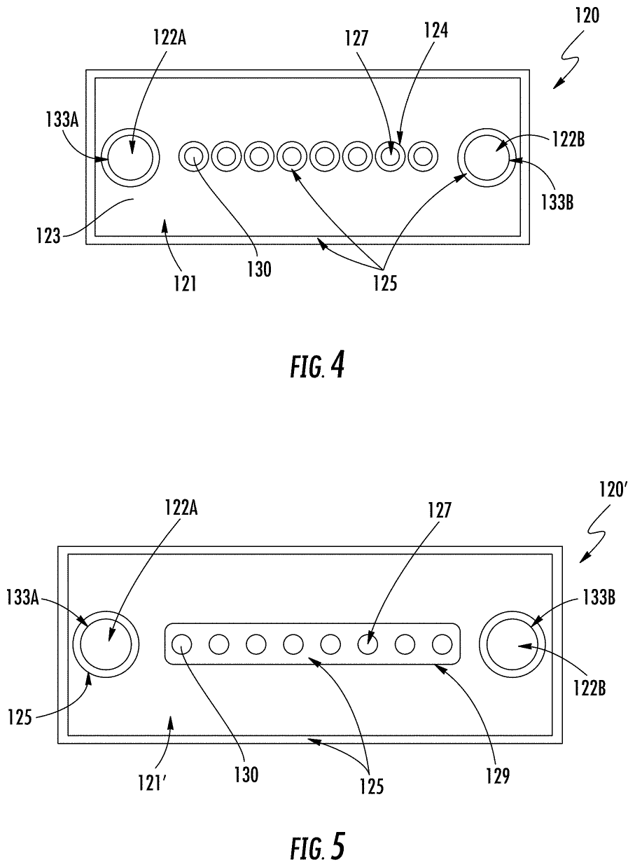

The glass faceplate 121 includes one or more glass fiber through-holes 124 into which one or more optical fibers (not shown) are disposed. FIG. 3A illustrates the glass faceplate 121 of FIG. 2 in isolation. FIGS. 2 and 3A illustrate twelve glass fiber through-holes 124, which corresponds to the twelve optical waveguides 116 of the optical chip 100. As described in more detail below, the glass fiber through-holes 124 of the glass faceplate 121 are aligned with fiber through-holes 127 (see FIG. 5) located within the plastic body 125.

In the illustrated example, the glass faceplate 121 comprises a first alignment hole 122A and a second alignment hole 122B outboard of the plurality of glass fiber through-holes 124. As described in more detail below, the first and second alignment holes 122A, 122B may be configured to receive first and second alignment pins of a mated receptacle, or to receive first and second alignment pins that are inserted into corresponding alignment holes of a mated receptacle.

The glass faceplate 121 is made of a material having a CTE closer to the CTE of the silicon (about 2.6 ppm/° C.) of the optical chip 100. The material chosen for the glass faceplate 121 may be any material having a CTE close to the CTE of the optical chip such that movement of the ends of the optical fibers 130 is prevented during operation of the optical chip (e.g., an operational temperature range of 10° C.-90° C.), and to enable multiple mating/de-mating cycles. As one non-limiting example, the glass faceplate 121 may be fabricated from borosilicate glass.

The glass faceplate 121 may have any thickness such that movement of the ends of the optical fibers 130 is restricted due to the operating temperature of the optical chip 100 as well as other electrical devices in proximity to the optical chip 100. As an example and not a limitation, the glass faceplate 121 has a thickness that is greater than or equal to 0.5 mm and less than or equal to 2.0 mm.

The diameter of the plurality of glass fiber through-holes 124 is configured to accept a desired plurality of optical fibers 130. The plurality of glass fiber through-holes 124 has a pitch that matches the pitch p of the plurality of optical waveguides 116 of the optical chip 100. As an example and not a limitation the diameter of the plurality of glass fiber through-holes 124 may be greater than or equal to 50 μm and less than or equal to 200 μm. In one non-limiting example, each of the glass fiber through-holes 124 is about 125 μm in diameter. In another non-limiting example, the plurality of fiber through-holes has a pitch of 125 μm and each fiber through hole of the plurality of fiber through holes has a diameter of 80 μm. It should be understood that other diameter and pitch values may be utilized for the plurality of glass fiber through-holes 124 depending on the particular application.

The plurality of glass fiber through-holes 124 and the first and second alignment holes 122A, 122B may be formed within the glass faceplate 121 by any known or yet-to-be developed process. As a non-limiting example, the plurality of glass fiber through-holes 124 may be formed by a laser-damage-and-etch process in which an ultrafast pulsed laser damages the glass material at the desired location of a through-hole. The damaged region(s) of the glass material etch at a significantly faster rate than the non-damaged region(s). Thus, with selective etching, precision through-holes may be created within the glass material.

Any laser-damage-and-etch process may be utilized to fabricate the glass fiber through-holes 124 within the glass faceplate 121. In one non-limiting process, a short-pulse laser in combination with line focus optics is used to drill a pilot hole or laser damage region, completely through the body of the glass sheet with each laser pulse. The line focus optics creates a focal line that is equal to or greater than the thickness of the glass faceplate 121. An advantage of this process is that each laser pulse fully forms a pilot hole or laser damage region. Thus, the time to make a pilot hole or laser damage region is extremely short (e.g., approximately, 10 psec with a single pulse, for example, or approximately hundreds of nanoseconds even with a complete burst pulse). The glass faceplate 121 may then be exposed to an etching solution, such as a hydrofluoric acid-based etching solution, to preferentially etch the pilot hole or damage line within the glass faceplate, thereby forming a glass fiber through-hole having the desired diameter. More detail regarding example laser line focus and etching processes is provided in U.S. Pat. Publ. No. 2015/0166395, which is hereby incorporated by reference in its entirety.

In other embodiments, a percussion laser-drilling process using a pulsed ultraviolet (UV) laser is used to drill through the glass faceplate to form a pilot hole or damage region. With each pulse, glass material is removed to sequentially drill the pilot hole. A depth of the beam waist of the pulsed laser beam is adjusted so that the drilling occurs deeper within the glass faceplate until the pilot hole or damage region extends fully though the glass faceplate 121. The glass faceplate may then be exposed to an etching solution to preferentially etch the pilot hole or damage region. In some embodiments, a sacrificial cover layer may be applied to a laser entrance surface or a laser exit surface of the glass faceplate to improve hole circularity and aspect ratio (i.e., the ratio of the hole opening diameter to the minimum diameter of the hole). Example percussion laser drilling and etching processes are described in U.S. Pub No. 2014/0147623 which is hereby incorporated by reference in its entirety.

Many glass faceplates 121 may be fabricated from a single large sheet of glass. The entire glass sheet, or many sheets simultaneously, may be etched to remove the glass material and form the desired through-holes. Further processing may be performed, such as processes to smooth the etched glass sheets. Individual glass faceplates 121 may be separated from the glass sheet by a score-and-break process (e.g., either mechanically or by a laser) or any other known or yet-to-be-developed singulation process.

The CTE-matched, precision-formed glass faceplate 121 and plastic body 125 forms a glass-plastic hybrid assembly. This glass-plastic hybrid assembly may be created in a single step using a plastic injection-molding process where the glass faceplate 121 is inserted into a molding die (not shown) before the thermoplastic (or thermoset) is injected. The molding die may be an un-modified molding die utilized to fabricate traditional optical fiber ferrules, such as MT-type optical fiber ferrules.

Referring to FIG. 3B, the glass faceplate 121 may be inserted into a molding die 140 such that a first alignment die pin 141A is inserted into the first alignment hole 122A of the glass faceplate 121, a second alignment die pin 141B is inserted into the second alignment hole 122B of the glass faceplate 121, and a plurality of fiber die pins 144 is inserted into the plurality of glass fiber through-holes 124.

In some embodiments, the diameters of the first alignment hole 122A, the second alignment hole 122B and the plurality of glass fiber through-holes 124 are larger than the outer diameters of the first alignment die pin 141A, the second alignment die pin 141B and the plurality of fiber die pins 144, respectively. Thus, when the molding die 140 is injected with plastic, plastic fills in the gaps between walls of the first alignment hole 122A, the second alignment hole 122B and the plurality of glass fiber through-holes 124 and the first alignment die pin 141A, the second alignment die pin 141B and the plurality of plurality of fiber die pins 144, respectively. Thus, the walls of the holes of the glass faceplate become lined with plastic material following the molding process. This results in one or more plastic fiber through-holes 127 within the glass fiber through-holes 124. Utilizing larger diameter through-holes relaxes the required tolerances of the glass faceplate 121, which, in turn, reduces the cost of manufacturing the glass faceplate 121.

The plastic material also forms a first alignment bore 133A and a second alignment bore 133B within the plastic body 125 that are aligned with the first and second alignment holes 122A, 122B of the glass faceplate 121. When the first and second alignment holes 122A, 122B have a larger diameter than the first and second alignment die pins 141A, 141B as shown in FIGS. 3 and 4, the first and second alignment bores 133A, 133B are disposed within the first and second alignment holes 122A, 122B.

FIG. 4 depicts a front view of an example optical fiber ferrule 120 after the injection molding process. As shown in FIG. 4, the glass faceplate 121 is surrounded by, and embedded within the plastic body 125. Further, plastic material of the plastic body 125 is also present within the first alignment hole 122A, the second alignment hole 122B and the plurality of glass fiber through-holes 124. The resulting injection molding process and presence of plastic material in the plurality of glass fiber through-holes 124 results in a plurality of fiber through-holes 127 having the desired diameter disposed within the glass fiber through-holes 124. Similarly, the presence of plastic material within the first and second alignment holes 122A, 122B yields a desired diameter.

It should be understood that, in other embodiments, the diameters of the first alignment hole 122A, the second alignment hole 122B and the plurality of glass fiber through-holes 124 are equal to, or slightly larger than, the outer diameters of the first alignment die pin 141A, the second alignment die pin 141B and the plurality of fiber die pins 144. In such embodiments, little to no plastic material is present within the holes of the glass faceplate 121.

Referring now to FIG. 5, a front view of another example optical fiber ferrule 120′ is schematically illustrated. In this example, the glass faceplate 121′ comprises a slot 129 rather than individual glass fiber through-holes 124 as depicted in FIGS. 2-4. Thus, the need to fabricate individual, precision glass fiber through-holes 124 is avoided. In this embodiment, the slot 129 allows the plastic material to flow more easily around the fiber die pins 144 during the molding process. The fiber die pins 144 form fiber through-holes 127 fabricated from plastic that are present within the slot 129. The presence of the glass faceplate 121′, and the location of the fiber through-holes 127 within the slot 129, constrains movement of the optical fibers 130 due to the CTE of the plastic material.

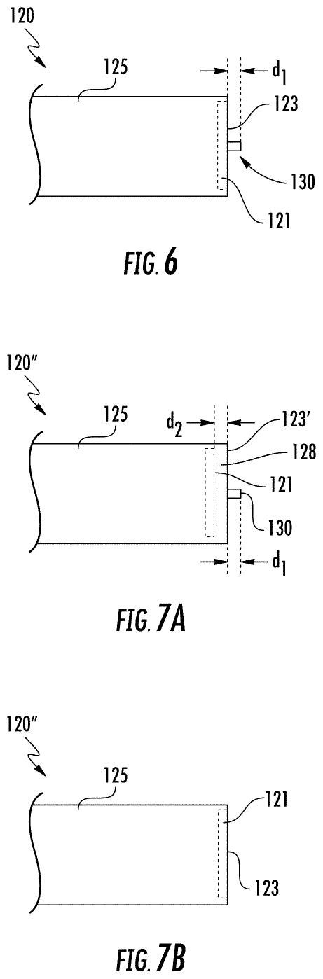

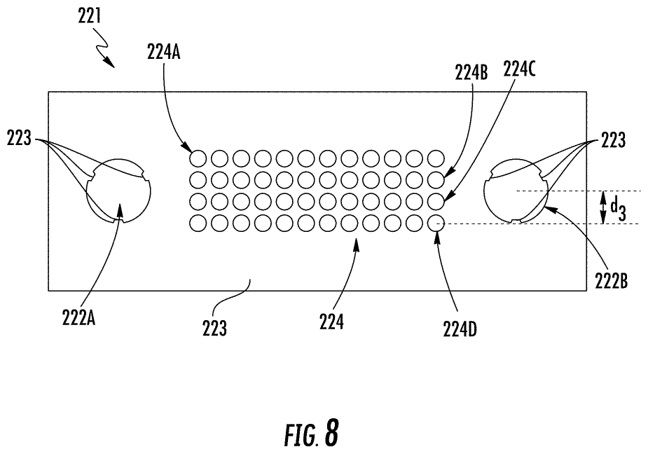

In yet other embodiments, the glass faceplate 121 is completely buried within the plastic body 125 proximate the end face of the optical fiber ferrule (see FIG. 7A, described below). This may be achieved by holding the glass faceplate 121 in the die using spacers (not shown) at a defined distance from the very front of the optical fiber ferrule 120. During molding, the front face of the optical fiber ferrule 120 will be covered with a layer of plastic (i.e., a plastic cover layer 128, FIG. 7A). The glass faceplate 121 of FIG. 4 or the glass faceplate 121′ of FIG. 5 may be buried within the plastic body 125, for example. The presence of the glass faceplate 121 prevents movement of the ends of the optical fibers.

In yet other embodiments, the entire optical fiber ferrule is fabricated from glass. In such an embodiment, all alignment bores and fiber through-holes or bores are disposed within the glass material of the glass optical fiber ferrule.

Referring to now FIG. 6, the optical fibers 130 may be disposed within the optical fiber ferrule 120 such that the optical fibers 130 extend beyond an end surface 123 of the optical fiber ferrule 120 by a distance d₁ (e.g., 1-2 μm). The end surface 123 may be polished such that the optical fibers 130 are flush with the end surface 123 defined by the glass faceplate 121.

When polishing the end faces of traditional optical fiber ferrules made of plastic, a certain amount of plastic material is removed from the end face (e.g., without limitation, about 100 μm). Thus, the embodiment wherein a plastic cover layer 128 is present on the glass faceplate 121 enables conventional polishing techniques to be used. FIG. 7A depicts a side view of an optical fiber ferrule 120″ wherein the glass faceplate 121 is embedded within the plastic body 125, and a plastic cover layer 128 is disposed on a front face of the glass faceplate 121. The optical fibers 130 extend beyond an end surface 123′ defined by the plastic cover layer 128. The plastic cover layer 128 has a thickness of d₂, which may be, without limitation, about 50 μm to about 200 μm. The thickness d₂ may be such that, when the optical fiber ferrule 120″ is polished by traditional polishing techniques, the plastic cover layer 128 is completely removed, thereby exposing the glass faceplate 121, as shown in FIG. 7B. In other embodiments, a portion of the plastic cover layer 128 may remain after the polishing process. In such embodiments, the geometry of the ferrule endface and fiber ends after polishing would be like that of a standard MT ferrule.

Additional features may be provided on either the glass faceplate 121 or a plastic cover layer 128 to reduce polishing time during manufacturing and reduce sensitivity to dust and debris when mated. As an example, one or more pedestals may be provided on the glass faceplate 121 or plastic cover layer 128, as described in International Patent Application WO/2016/053674, which is hereby incorporated by reference in its entirety.

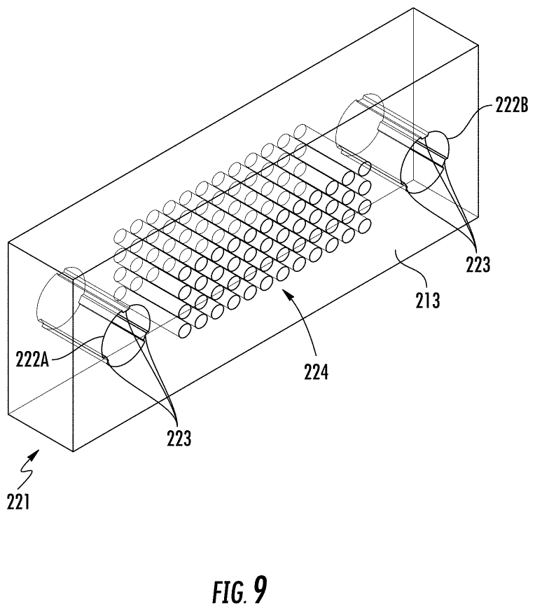

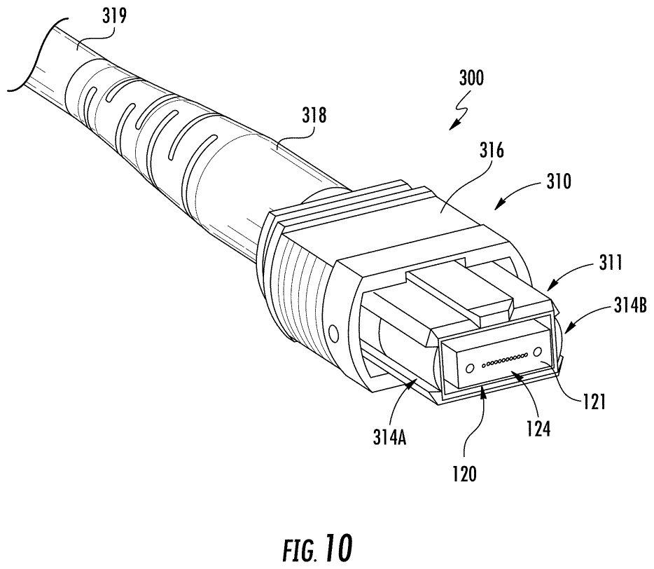

As stated above, the glass faceplate may take on many configurations. FIGS. 8 and 9 schematically depict a glass faceplate 221 having a plurality of glass fiber through-holes 224 defined by a first row of glass fiber through-holes 224A, a second row of glass fiber through-holes 224B, a third row of glass fiber through-holes 224C, and a fourth row of glass fiber through holes 224D. A first alignment hole 222A and a second alignment hole 222B are located outboard of the plurality of glass fiber through-holes 224. In the illustrated embodiment, the first alignment hole 222A and the second alignment hole 222B each have tab features 223 that are configured to contact alignment die pins during the molding process so that the alignment die pins are precisely positioned within the first alignment hole 222A and the second alignment hole 222B. It should be understood that other configurations are also possible.

As noted hereinabove, the optical fiber ferrules described herein may be incorporated into a fiber optic connector. FIG. 10 schematically depicts a perspective view of an example fiber optic connector 300 configured as an MT-type connector. It should be understood that embodiments described herein are not limited to the fiber optic connector depicted in FIG. 10, and that the optical fiber ferrules described herein may be provided in other connector configurations. The example fiber optic connector 300 comprises a connector housing 310, an optical fiber ferrule 120 having a glass faceplate 121, a strain relief 318, and a fiber optic cable 319. In the illustrated embodiment, the connector housing 310 includes an inner housing 311 and an outer housing 316 that surrounds the inner housing 311. The inner housing 311 may include a keying feature 312 to ensure that the fiber optic connector 300 is connected to a corresponding receptacle in a proper orientation. The inner housing 311 may also include notches 314 that engage corresponding features of a receptacle (not shown) to facilitate engagement between the fiber optic connector 300 and a mated receptacle. The optical fiber ferrule 120 is exposed by the inner housing 311. One or more optical fibers (not shown) are disposed within the fiber optic cable 319 and the optical fiber ferrule 120.

The optical fiber ferrules described herein are configured to be mechanically coupled to an edge of an optical chip. In embodiments, a receptacle structure is mounted on the optical chip that is configured to receive the optical fiber ferrules described herein. The receptacle of the optical chip may take on many configurations.

Embodiments of the present disclosure are also directed to receptacles that make use of an upper (or lower) surface of an optical chip as a reference datum by placing alignment pins directly on the surface of the optical chip and holding them in place via a receptacle body. As described in more detail below, in case of a flat optical chip surface, the alignment pins are fixed by grooves (e.g., V-shaped grooves) in the receptacle body that is adhered to the optical chip. In some embodiments, structures are provided on the optical chip surface that position the alignment pins and secure the alignment pins in place by means of a simple flat-surface receptacle body. The receptacle body may be made of a glass material having a CTE substantially the same as the material of the optical chip, thus reducing stress and potential movement during solder reflow. Depending on the material and design of the optical chip, different coefficients of thermal expansion can be matched via the selection of an appropriate glass. As non-limiting examples, Pyrex® and Corning Eagle XG® glass (CTE of 3.2 ppm/C) are well matched to silicon (2.6 ppm/C).

FIG. 11 schematically illustrates a top view of an example optical fiber ferrule 120 and an optical chip 100. An example receptacle 150 is attached to the first surface 113 of the optical chip 100 proximate the edge 112. The example receptacle 150 comprises a receptacle body 151 that is attached to the first surface 113 of the optical chip 100. The receptacle body 151 may be precisely positioned on the first surface 113 with respect to the optical waveguides 116 by a passive alignment process using a vision system, for example. As described in more detail below, alignment fiducials may be located on the first surface 113 to assist in the precise placement of the receptacle body 151 with respect to the optical waveguides 116. As another example, precise mechanical alignment features, such as posts, tabs, recesses, trenches, and the like may be incorporated into the first surface and/or the receptacle body 151 for precise positioning of the receptacle body 151.

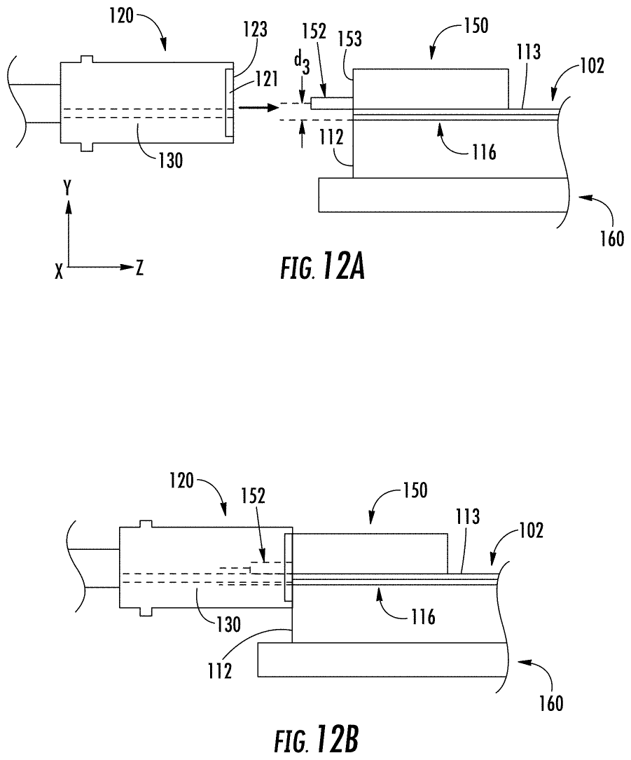

Referring now to FIG. 12A, an optical connection comprising an optical fiber ferrule 120, a receptacle 150 and an optical chip 100 is schematically illustrated. The receptacle 150 is mounted to the first surface 113 of the optical chip 100. The optical chip 100 is further mounted on a base substrate 160, such as a circuit board defining a daughter board. The alignment pins 152 extend beyond the mating face 153 and the edge 112 of the optical chip 100. In the illustrated embodiment, as the alignment pins 152 (i.e., first alignment pin 152A and second alignment pin 152B) are located on the first surface 113, the alignment pins 152 are offset from the optical waveguides 116 in a y-axis direction by an offset distance d₃. Thus, when mating an optical fiber ferrule to a receptacle 150 as illustrated in FIG. 12A, the glass fiber through-holes 124 should be offset from the first and second alignment holes 122A, 122B by the offset distance d₃. In one example, the glass faceplate 221 and a resulting glass-plastic hybrid optical fiber ferrule is utilized to accommodate the offset distance d₃. The glass faceplate 221 has forty-eight glass fiber through-holes 224 arranged in four rows according to industry standards. The alignment pins 152 of the receptacle 150 may be arranged on the first surface 113 of the optical chip 100 such that the distance between the alignment pins 152 and the optical waveguides is equal to the offset distance d₃. Therefore, the bottom row 224D of the glass fiber through-holes 224 (FIG. 8) will be aligned with optical waveguides 116 when the optical fiber ferrule 120 is mated with the receptacle 150 and optical chip 100 by inserting the alignment pins 152 of the into the alignment bores (e.g., first alignment hole 122A and second alignment hole 122B), as shown in FIG. 12B. Thus, in this embodiment, only the bottom row 224D of the glass fiber through-holes 224 will pass optical signals.

Use of a standard ferrule configuration, such as the forty-eight fiber arrangement depicted in FIG. 8, to accommodate the offset distance d₃ may be advantageous because conventional tooling may be utilized to manufacture the glass-plastic hybrid optical fiber ferrules described herein. It should be understood that other arrangements are possible. For example, the glass faceplate may only include a single row of glass fiber through-holes offset from the alignment through-holes.

It is noted that the alignment pins described herein may be disposed within the optical fiber ferrule rather than the receptacle. Alternatively, each of the optical fiber ferrule and the receptacle may include at least one alignment pin and at least one alignment bore. Other configurations are also possible. It is further noted that other mechanical components may be provided on the optical fiber ferrule and/or the receptacle to secure the optical fiber ferrule to the receptacle and optical chip such as, without limitation, latches, tabs, magnets, and the like.

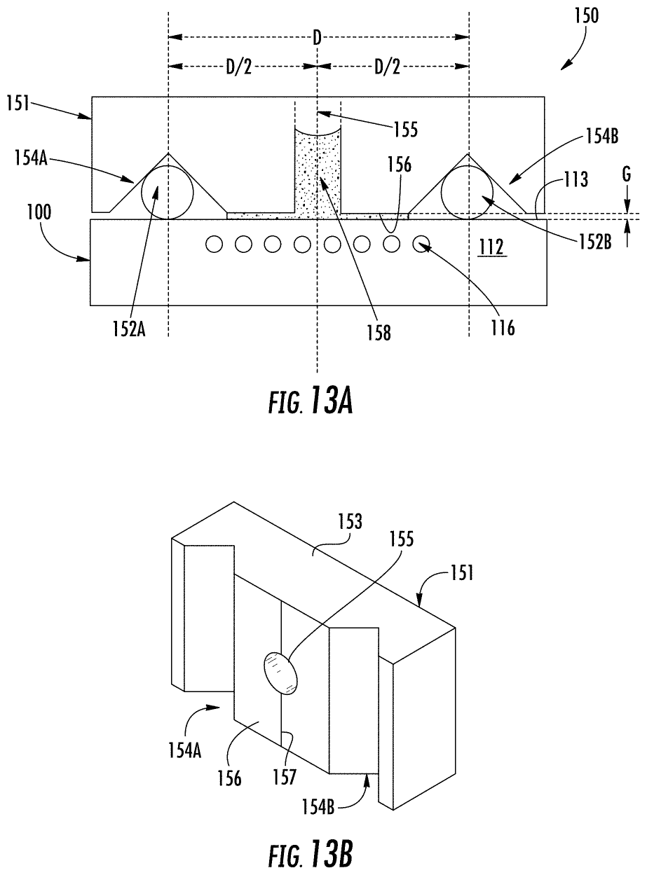

FIGS. 13A-13C depict an example receptacle optical connection. FIG. 13A is a front view of an example optical chip 100 and receptacle 150 comprising a receptacle body 151. FIG. 13B is a bottom perspective view of the receptacle body 151 depicted in FIG. 13A. FIG. 13C is close-up, front view of the example optical chip 100 and receptacle 150 depicted in FIG. 13A.

The example receptacle body 151 includes a mating face 153, and a first alignment groove 154A and a second alignment groove 154B operable to maintain a first alignment pin 152A and a second alignment pin 152B, respectively. In the illustrated embodiment, the first and second alignment pins 152A, 152B are disposed between the first surface 113 and the receptacle body 151, and may be secured using an adhesive 158, for example. The example receptacle body 151 further comprises a through-hole 155 through which an adhesive 158 may be disposed to secure the receptacle body 151 and the first and second alignment pins 152A, 152B to the optical chip 100. The adhesive 158 should be an adhesive 158 that remains dimensionally stable during the solder reflow process (e.g., about 260° C.). A receptacle body 151 fabricated from glass will make it possible to cure the adhesive 158 with ultra-violet radiation, as the ultra-violet radiation will pass through the glass receptacle body.

As shown in FIG. 13A, the adhesive 158 wicks into a small gap G between the receptacle body 151 and the first surface 113 of the optical chip 100. Symmetrical placement of the through-hole 155 and the first and second alignment grooves 154A, 154B may prevent undesired movement of the receptacle body 151 and first and second alignment pins 152A, 152B. In the illustrated embodiment, a center of the first alignment groove 154A is separated from a center of the second alignment groove 154B by a distance D. In embodiments, the distance between the center of the first alignment groove 154A and a center of the through-hole 155 may be D/2, and the distance between the center of the through-hole 155 and the center of the second alignment groove 154B may also be D/2. In some embodiments, the through-hole 155 is symmetrically positioned within the receptacle body 151 along two orthogonal directions (e.g., left-right and front-back).

It is noted that, although FIG. 13A illustrates the adhesive 158 as not contacting the first and second alignment pins 152A, 152B, embodiments are not limited thereto. The adhesive may contact the first and second alignment pins 152A, 152B. In some embodiments, shrinkage of the adhesive 158 during curing may cause the adhesive to pull away from the first and second alignment pins 152A, 152B such that the first and second alignment pins 152A, 152B are maintained by friction between the receptacle body 151 and the optical chip 100.

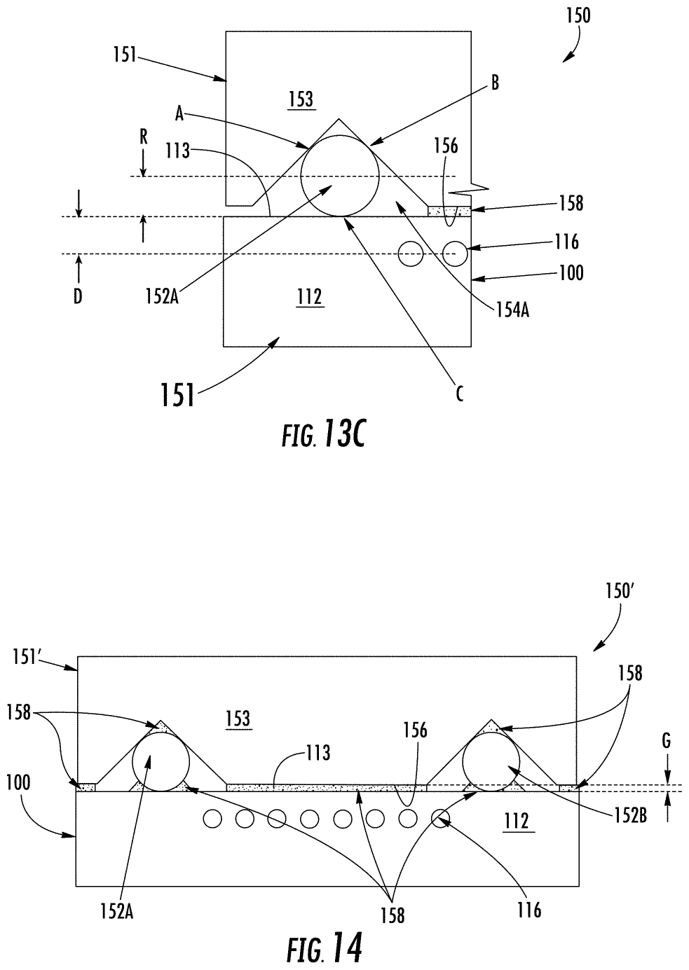

Depending on the overall geometry and the indices of refraction of the materials, application of an adhesive 158 right above the buried chip optical waveguides 116 (as shown in FIG. 13A) may affect their light guiding properties. Thus, in some embodiments, application of adhesive 158 proximate the chip optical waveguides 116 may be avoided by applying the adhesive outside of the waveguide area, as shown in FIG. 14. In the example receptacle body 151′ of the example receptacle 150′ depicted by FIG. 14, no center through-hole is provided. Rather, adhesive 158 is disposed between the first and second alignment grooves 154A, 154B and the first and second alignment pins 152A, 152B, respectively, and between the first and second alignment pins 152A, 152B and the first surface 113 of the optical chip 100.

A transparent glass receptacle body 151 with one or more fiducial marks or structures added to its bottom surface may be aligned to corresponding fiducial marks or structures on top of the optical chip 100 by machine vision, thus avoiding the need for active alignment. The one or more fiducial marks may take on any form. The example receptacle body 151 depicted in FIG. 13B further includes a center line 157 at a bottom surface 156 that may be used as an alignment fiducial mark that is aligned with respect to one or more corresponding alignment fiducial marks located on the first surface 113 of the optical chip 100 (not shown). The center line 157 may be configured as markings disposed on the bottom surface 156 of the receptacle body 151, or as a feature that is fabricated during manufacturing, such as during a molding process. It should be understood that more than one alignment fiducial may be provided on the receptacle body 151, and that the alignment fiducial(s) may take on shapes other than a line (e.g., circles, ellipses, crosses, and the like).

Referring to FIG. 13C, the receptacle body 151 does not directly contact the first surface 113 of the optical chip 100. The receptacle body 151 contacts the first alignment pin 152A and the second alignment pin 152B at a first location A and a second location B. The optical chip 100 contacts the first alignment pin 152A and the second alignment pin 152B at a third location C. Because there is only line contact between the first and second alignment pins 152A, 152B and the first surface 113 of the optical chip 100, the final positions of the first and second alignment pins 152A, 152B are less sensitive to the impact of foreign particles on the first surface 113 than it would be in the case of contact between two extended surfaces. As the design avoids any part in between the two defining precision components (first surface 113 of the optical chip 100 and the first and second alignment pins 152A, 152B), stacking of dimensional tolerances is kept to a minimum. As shown in FIG. 13C, only two dimensions define the distance between the center of the optical waveguides 116 and the center of the first and second alignment pins 152A, 152B: the depth of the optical waveguides 116 D and the radius R of the first and second alignment pins 152A, 152B.

Further, tight geometrical tolerances may be desired only for the separation of the first alignment groove 154A and the second alignment groove 154B, thereby greatly reducing cost of manufacturing. Compared to a full free-space alignment with six degrees of freedom, the receptacle body 151 may be more easily aligned as the design removes two rotational (pitch and roll) and one translational (shown in FIG. 13A) degree of freedom during receptacle body 151 placement.

The receptacle body 151, 151′ depicted by FIGS. 13A-13C and 14 provides the proper placement and alignment of the first and second alignment pins 152A, 152B. In the example optical chip 100″ and receptacle 150″ depicted by FIG. 15, the positions of the first and second alignment pins 152A, 152B are set by features of the optical chip 100″. In the optical connection of FIG. 15, the first surface 113″ of the optical chip 100″ includes at least a first optical chip groove 115A″ and a second optical chip groove 115B″ separated by a distance D. The first optical chip groove 115A″ and the second optical chip groove 115B″ may be fabricated by a variety of processes depending on the material of the optical chip 100″ (e.g., silicon), such as, without limitation, lithography and etching, laser ablation, and/or laser damage and etching processes. As shown in FIG. 15, the first and second optical chip grooves 115A″, 115B″ may be configured as V-shaped grooves, as a non-limiting example. The first and second optical chip grooves 115A″, 115B″ may extend on the first surface 113″ from an edge 112″.

The first and second alignment pins 152A, 152B are disposed in the first and second optical chip grooves 115A″, 115B″, respectively. In the case where the first and second optical chip grooves 115A″, 115B″ are configured as V-shaped grooves, the first and second alignment pins 152A, 152B make linear contact with the first and second optical chip grooves 115A″, 115B″ at only two locations and thus are less sensitive to misalignment due to the presence of foreign particles.

The example receptacle body 151″ maintains the first and second alignments pins 152A, 152B within the first and second optical chip grooves 115A″, 115B″. The example receptacle body 151″ comprises a pedestal 159″ adjacent a first pin support surface 156A″ and a second pin support surface 156C″. The first pin support surface 156A″ contacts the first alignment pin 152A and the second pin support surface 156C″ contacts the second alignment pin 152B such that a gap G is present between a pedestal support surface 156B″ and the first surface 113 of the optical chip 100″. Thus, the first and second alignment pins 152A, 152B each make linear contact with the optical chip 100″ and the receptacle body 151″ at three locations.

Similar to the receptacle body 151 depicted in FIG. 13A, the example receptacle body 151″ comprises a centrally located through-hole 155″ for receiving adhesive 158. The through-hole 155″ may be positioned within the receptacle body 151″ such that a first distance between a center of the first optical chip groove 115A″ and a center of the through-hole 155″ is D/2, and a second distance between the center of the through-hole 155″ and a center of the second optical chip groove 115B″ is also D/2. As shown in FIG. 15, the adhesive 158 wicks into the gap G between the receptacle body 151″ and the first surface 113″ of the optical chip 100″. The symmetrical position of the through-hole 155″ and the first and second optical chip grooves 115A″, 115B″ may prevent undesired movement of the receptacle body 151″ and first and second alignment pins 152A, 152B. The symmetrical position of the through-hole 155″ may assist in maintaining correct alignment of the first and second alignment pins 152A, 152B during application of the adhesive as well as during curing of the adhesive (i.e., minimize the effect of shrinkage of the adhesive). It should be understood that the adhesive may also contact the first and second alignment pins 152A, 152B, in some embodiments.

In the receptacle body embodiments described above and illustrated in FIGS. 13A, 13B, 13C, 14, and 15, the first alignment pin 152A and the second alignment pin 152B make one-dimensional linear contact with the receptacle body or optical chip at three locations (e.g., see locations A, B and C). While one dimensional line contacts, as compared to two dimensional contact surfaces, already reduces the probability of any foreign particles (dust, machining debris) preventing correct alignment of the designed components, this probability may be further reduced by breaking up the lines of contact into multiple shorter segments. This way, the alignment is still maintained but the actual length of line contact is reduced.

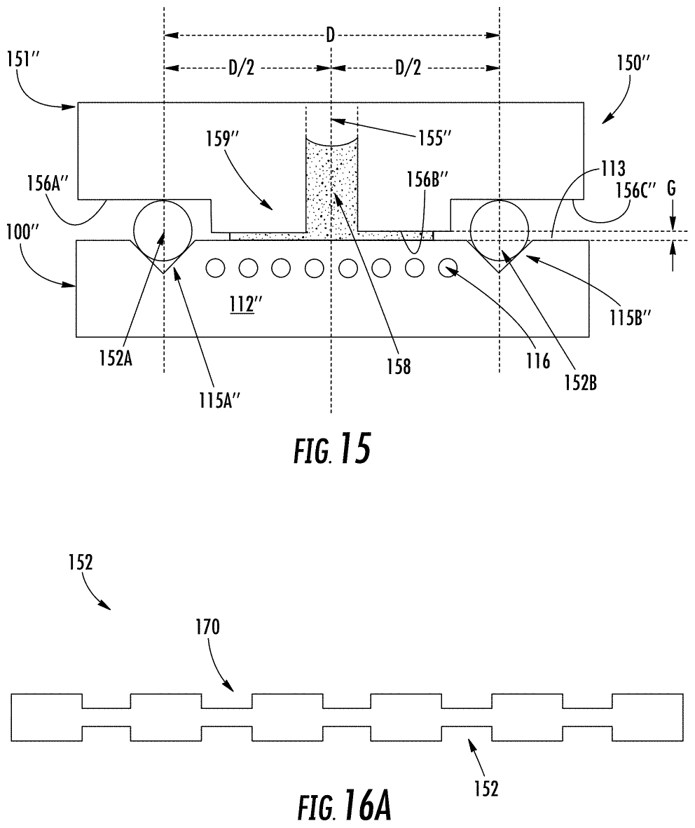

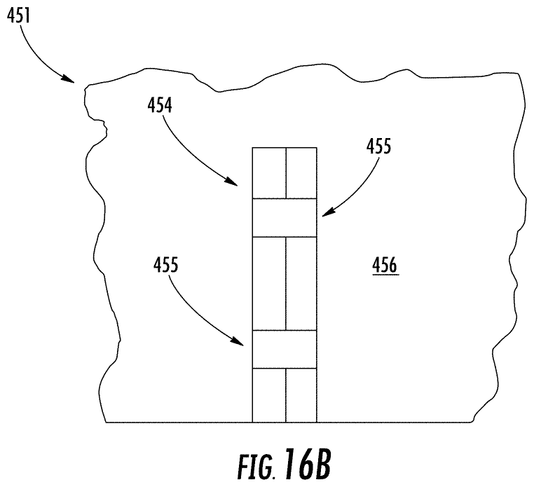

Breaking up the lines of contact into segments may be achieved by machining additional features into any of the three components: the alignment pins, the alignment grooves of the receptacle body, and optical chip waveguides of the optical chip. FIG. 16A schematically depicts an example alignment pin 152 having a plurality of circumferential sub-grooves 170. For example, the sub-grooves 170 may be machined around the circumference of the alignment pins 152. Alternatively, one or more sub-grooves may be fabricated in the alignment grooves of the optical chip 100 and/or the receptacle body 151 to break up the lines of contact with the alignment pins 152. Referring to FIG. 16B, a partial view of a bottom surface 456 of an example receptacle body 451 is schematically illustrated. An example alignment groove 454 is configured as a V-shaped groove. The alignment groove 454 has two sub-grooves 455 that are formed at ninety degrees from the V-groove walls, effectively breaking up the contact line into multiple segments. Any number of sub-grooves and any configuration are possible. It should be understood that the optical chip grooves described herein may also include sub-grooves as described herein.

In some embodiments, the first and second alignment pins 152A, 152B may comprise one or more flexible features to increase flexibility to compensate for the higher elastic modulus of glass compared to that plastic. Example alignment pins including flexible alignment features are described in U.S. Pat. No. 8,768,125, which is hereby incorporated by reference in its entirety. Thus, flexible alignment pins may more easily be inserted into the alignment holes or bores provided by the more rigid glass material of the glass faceplate 121.

It is noted that, in other embodiments, the receptacle body may include alignment bores to maintain the first and second alignment pins 152A, 152B rather than the first and second alignment grooves 154A, 154B. For example, the receptacle body 151 may be molded over the first and second alignment pins 152A, 152B. It should be understood that many other receptacle configurations are also possible.

It will be apparent to those skilled in the art that various modifications and variations can be made without departing from the spirit or scope of the disclosure. Since modifications, combinations, sub-combinations and variations of the disclosed embodiments incorporating the spirit and substance of the disclosure may occur to persons skilled in the art, the disclosure should be construed to include everything within the scope of the appended claims and their equivalents.

We claim:

1. A receptacle body for an optical connection, the receptacle body comprising:
a first surface;
a second surface;
a first groove at the second surface;
a second groove at the second surface; and
a through-hole extending from the first surface to the second surface, wherein the through-hole is disposed between the first groove and the second groove.

2. The receptacle body of claim 1, wherein a first distance between a center of the first groove and a center of the through-hole is substantially equal to a second distance between a center of the second groove and the center of the through-hole.

3. The receptacle body of claim 1, further comprising at least one fiducial mark located on the second surface.

4. The receptacle body of claim 3, wherein the at least one fiducial mark comprises a line extending from a first edge of the receptacle body to a second edge of the receptacle body, and the line passes through a center of the of the through-hole at the second surface.

5. The receptacle body of claim 1, wherein the first groove and the second groove are V-shaped grooves.

6. The receptacle body of claim 1, wherein the first groove and the second groove extend from a first edge of the receptacle body to a second edge of the receptacle body.

7. The receptacle body of claim 1, wherein the first groove and the second groove each comprise a first edge, a second edge, and one or more sub-grooves extending from the first edge to the second edge of the first groove and the second groove, respectively.

8. An optical connection comprising:
an optical chip comprising:
a surface;
an edge extending from the surface; and
at least one optical waveguide within the optical chip and terminating at the edge;
a receptacle body comprising:
a first surface;
a second surface;
a first groove at the second surface;
a second groove at the second surface; and
a through-hole extending from the first surface to the second surface, wherein the through-hole is disposed between the first groove and the second groove;
a first alignment pin disposed on the surface of the optical chip and within the first groove of the receptacle body; and
a second alignment pin disposed on the surface of the optical chip and within the second groove of the receptacle body, wherein:
a gap defined between the surface of the optical chip and the second surface of the receptacle body; and
an adhesive is disposed within the gap.

9. The optical connection of claim 8, wherein the adhesive is further at least partially disposed within the through-hole of the receptacle body.

10. The optical connection of claim 8, wherein a first distance between a center of the first groove and a center of the through-hole is substantially equal to a second distance between a center of the second groove and the center of the through-hole.

11. The optical connection of claim 8, further comprising:
at least one fiducial mark located on the second surface of the receptacle body; and
at least one optical chip fiducial mark located on the optical chip, wherein the at least one fiducial mark is aligned with respect to the at least one optical chip fiducial mark.

12. The optical connection of claim 11, wherein the at least one fiducial mark comprises a line extending from a first edge of the receptacle body to a second edge of the receptacle body, and the line passes through a center of the through-hole at the second surface.

13. The optical connection of claim 8, wherein the first groove and the second groove are V-shaped grooves.

14. The optical connection of claim 8, wherein the first groove and the second groove extend from a first edge of the receptacle body to a second edge of the receptacle body.

15. The optical connection of claim 8, wherein the first groove and the second groove each comprise a first edge, a second edge, and one or more sub-grooves extending from a first edge to a second edge of the first groove and the second groove, respectively.

16. The optical connection of claim 8, wherein the first alignment pin and the second alignment pin each comprise one or more circumferential grooves.

17. A receptacle body for an optical connection, the receptacle body comprising:
a first surface;
a first pin support surface and a second pin support surface;
a pedestal comprising a pedestal surface, wherein the pedestal is disposed between the first pin support surface and the second pin support surface, and the pedestal surface is offset from the first pin support surface and the second pin support surface; and
a through-hole extending from the first surface to the pedestal surface.

18. The receptacle body of claim 17, wherein a first distance between a first edge of the receptacle body and a center of the through-hole is substantially equal to a second distance between a second edge of the receptacle body and the center of the through-hole.

19. The receptacle body of claim 17, further comprising at least one fiducial mark located on the pedestal surface.

20. An optical connection comprising:
an optical chip comprising:
a surface;
an edge extending from the surface;
at least one optical waveguide within the optical chip and terminating at the edge;
a first optical chip groove within the surface; and
a second optical chip groove within the surface;
a receptacle body comprising:
a first surface;
a first pin support surface and a second pin support surface;
a pedestal comprising a pedestal surface, wherein the pedestal is disposed between the first pin support surface and the second pin support surface, and the pedestal surface is offset from the first pin support surface and the second pin support surface; and
a through-hole extending from the first surface to the pedestal surface;
a first alignment pin disposed within the first optical chip groove such that the first alignment pin is disposed between the optical chip and the first pin support surface of the receptacle body; and
a second alignment pin disposed within the second optical chip groove such that the second alignment pin is disposed between the optical chip and the second pin support surface of the receptacle body, wherein:
a gap defined between the surface of the optical chip and the pedestal surface of the receptacle body; and
an adhesive is disposed within the gap.

21. The optical connection of claim 20, wherein the adhesive is further at least partially disposed within the through-hole of the receptacle body.

22. The optical connection of claim 20, wherein a first distance between a first edge of the receptacle body and a center of the through-hole is substantially equal to a second distance between a second edge of the receptacle body and the center of the through-hole.

23. The optical connection of claim 20, further comprising:
at least one fiducial mark located on the pedestal surface of the receptacle body; and
at least one optical chip fiducial mark located on the optical chip, wherein the at least one fiducial mark is aligned with respect to the at least one optical chip fiducial mark.

24. The optical connection of claim 20, wherein the first optical chip groove and the second optical chip groove each comprise one or more sub-grooves extending from a first edge to a second edge of the first optical chip groove and the second optical chip groove, respectively.

25. The optical connection of claim 20, wherein the first alignment pin and the second alignment pin each comprise one or more circumferential grooves.
